(19) United States
(12) Patent Application Publication
(10) Pub. No.: US 2013/0281252 A1
(43) Pub. Date: Oct. 24, 2013

(54) Differential Gear

(71) Applicant: Neumayer Tekfor Holding GmbH, Hausach (DE)

(72) Inventors: Kathrin FUCHS, Steinach (DE); Steffen KONSTANZER, Boetzingen (DE)

(21) Appl. No.: 13/923,439

(22) Filed: Jun. 21, 2013

Related U.S. Application Data
(63) Continuation of application No. PCT/DE2010/001519, filed on Dec. 23, 2010.

(51) Int. Cl. F16H 48/08

(52) U.S. Cl. CPC F16H 48/08
USPC 475/230; 475/220

(57) ABSTRACT

A differential gear is provided in which the differential includes a drive gear, at least two axle gears, at least two compensating gears and a single-piece connecting element. The drive gear at least partially encloses an interior space in which the connecting element is arranged, thereby providing a compact, strong differential without use of a differential cage.

### CROSS REFERENCE TO RELATED APPLICATION

This application is a continuation of PCT International Application No. PCT/PCT/DE2010/001519, filed Dec. 23, 2010, the entire disclosure of which is herein expressly incorporated by reference.

### BACKGROUND AND SUMMARY OF THE INVENTION

The invention relates to a differential comprising at least one drive gear, at least two axle gears, at least two compensating gears and at least one connecting element.

A differential is a special planetary gear which, for example, in the case of a vehicle travelling in a curved path, compensates for the different distance that is traversed by the two wheels of one axle, since the wheels rotate at different speeds. To this end, a connecting element receives a drive torque from a drive gear and, as a result, is brought into rotation. The drive gear is connected to a transmission gear unit and to an actual automotive engine via this transmission gear unit. The connecting element transmits a torque to the two compensating gears, wherein the transmitted torque is dependent on the predetermined drive torque. At the same time the compensating gears are in engagement with the axle gears. In the event that a difference in speed arises between the two wheels, the compensating gears rotate with the effect that one wheel rotates at a higher speed. The connecting element in the prior art is generally a differential cage, within which the axle gears and the compensating gears are arranged and which is connected on the periphery to the drive gear. The International patent publication WO 2010/118727 A1 of the applicant discloses a novel differential, in which the connecting element is arranged in the drive gear. The single-piece connecting element has pins that are configured for the axle gears and the compensating gears and that in turn extend like a star from a central region of the connecting element. Consequently such a differential dispenses with the differential cage, but, in particular, a single-piece connecting element is subject to a high load.

The object of the present invention is to optimize such a caseless differential.

This engineering object is achieved according to the invention in that the drive gear is constructed in the manner of a gearwheel, that the drive gear is constructed in such a way that it at least partially encloses an interior space, that the connecting element is arranged at least partially inside an interior space, that the connecting element is constructed as a single piece, that the connecting element has at least six pins, which extend like a star from a central region of the connecting element, that the connecting element has at least two axle gear pins, about which one of the at least two axle gears can rotate, that the at least two axle gear pins are arranged along a first imaginary axis of the connecting element, that the connecting element has at least two compensating gear pins, about which one of the at least two compensating gears can rotate, that the at least two compensating gear pins are arranged along a secondary imaginary axis of the connecting element, wherein the second imaginary axis is in essence perpendicular to the first imaginary axis, that the at least two compensating gear pins are connected to the inner surface of the drive gear, and that the connecting element has at least two fastening pins, which are connected to the inner surface of the drive gear. In particular, the connecting element receives at least a first torque from the drive gear and transmits at least a second torque to at least one of the at least two axle gears. One design variant provides that the central region of the connecting element is arranged to be in essence symmetric about the center of gravity of the drive gear. For the distribution of the forces and moments that arise, the connecting element, for example, a one-part or more specifically a single-piece forged part, is connected, for example, welded, to the drive gear by the four pins. This arrangement reduces the load acting on the connecting element. The connecting element has in total at least six pins: two axle gear pins, two compensating gear pins and two fastening pins. The axle gears and the compensating gears may be found, in particular, partially meshing with one another. The imaginary axis, along which the fastening pins are arranged, is preferably in essence perpendicular to the first and the second imaginary axis.

One embodiment of the invention provides that the at least two axle gears have direct contact with the axle gear pins, in particular without bushings, and/or that the at least two compensating gears have direct contact with the compensating gear pins, in particular without bushings. In the International patent publication WO 2010/118727 A1, two bushings are provided in each case for the axle gears and/or the compensating gears. However, it has also proved to be advantageous to mount the gears directly on the pins without bushings.

One embodiment of the invention comprises that at least one backing piece is arranged on the at least two compensating gear pins, in particular, on the side of the compensating gears that faces away from the central region of the connecting element, wherein the at least one backing piece is connected to the inner surface of the drive gear, and/or that at least one backing piece is arranged on the at least two fastening pins, wherein the at least one backing piece is connected to the inner surface of the drive gear. Consequently one embodiment provides at least four backing pieces (two on the compensating gear pins and two on the fastening pins), which are connected to the inner surface of the drive gear. The backing pieces of the compensating gears serve, among other things, to axially support the compensating gears or to adjust the backlash between the gears. Furthermore, the backing pieces offer the advantage of a reinforcement of the differential or more specifically the pins.

One embodiment of the invention provides that the drive gear and at least one compensating gear pin are constructed and adapted relative to one another in such a way that at least one cavity is formed between the compensating gear pin and the inner surface of the drive gear. During the welding operation, a weld root can form in this cavity. In this case the cavity is dimensioned in such a way that when the pins are welded on both sides to the drive gear, contact with the other material, penetrating into the cavity, that is, the weld root, is prevented. In this case the cavity is located behind a welded joint.

One embodiment of the invention comprises that at least one backing piece has at least one recess. In this case the recess opens on a region, at which the pin, about which the backing piece is arranged, impinges on the inner surface of the drive gear. Thus, the backing piece is constructed in such a way that it allows welding between the associated pin and the drive gear. Preferably all of the backing pieces are constructed in this way. Preferably the backing pieces adapt to the inner surface of the drive gear in such a way that the result is an optimal weld for the connection of the backing pieces to the drive gear. Hence, the backing pieces are, for example, curved.

One embodiment of the invention provides that at least one axle gear and/or at least one compensating gear have/has at least one drilled hole. In this case the drilled hole(s) empty/empties into a region, in which the axle gear has contact with the axle gear pin and/or in which the compensating gear has contact with the compensating gear pin. The drilled holes serve, in particular, to supply oil. In this case the oil is one example of a lubricant.

One embodiment of the invention comprises that at least one axle gear pin and/or at least one compensating gear pin have/has at least partially circumferential depressions. These depressions, which extend, if desired, in the manner of helix or spiral, serve to supply oil uniformly around the pins.

One embodiment of the invention provides that at least one housing is provided; that the ends of the axle gear pins are arranged in each instance in a blind hole of the axle gears; that the axle gears partially project from the housing; and that the housing is constructed and/or is sealed off in essence oil tight. As a result, the differential according to the invention offers the advantage that during a disassembly of the side shafts, there is no risk of a loss of oil as in the prior art. The arrangement of the axle gear pins in the blind bores of the axle gears can also be used for an open housing or more specifically without a housing.

One embodiment of the invention comprises that the axle gears are mounted by means of tapered roller bearings. In this case the tapered roller bearings are arranged along the first imaginary axis at least partially in a region, in which the axle gears have contact with the axle gear pins. The arrangement of the tapered roller bearings, which are arranged, for example, between the axle gears and the housing, serves to reduce the acting forces. The tapered roller bearings absorb the axial forces and function to guide the axle gears.

One embodiment of the invention provides that the at least two axle gears and the at least two compensating gears are constructed as bevel gears, or that the at least two axle gears are constructed as crown gears, and the at least two compensating gears are constructed as spur gears, or that the at least two axle gears are constructed as spur gears, and the at least two compensating gears are constructed as crown gears. One embodiment of the invention comprises that the drive gear has a straight, oblique, herringbone or double helical tooth gearing. One embodiment of the invention comprises that at least one of the at least two axle gears has an outer profile or an inner profile for establishing an attachment to a shaft and/or a gear. For example, an external tooth system or an internal tooth system is provided in order to establish an attachment.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a sectional view of a differential according to an embodiment of the invention.

FIG. 2 is a cut spatial representation of the differential shown in FIG. 1.

FIG. 3 is an additional sectional view through the differential shown in FIG. 1; and

FIG. 4 is a sectional view of an alternative embodiment of the differential of the invention.

### DETAILED DESCRIPTION OF THE DRAWINGS

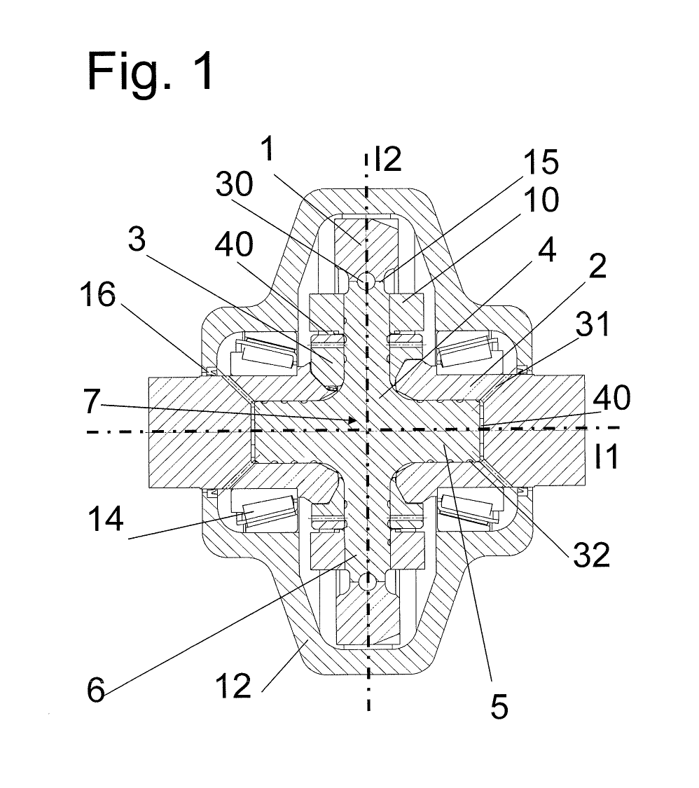

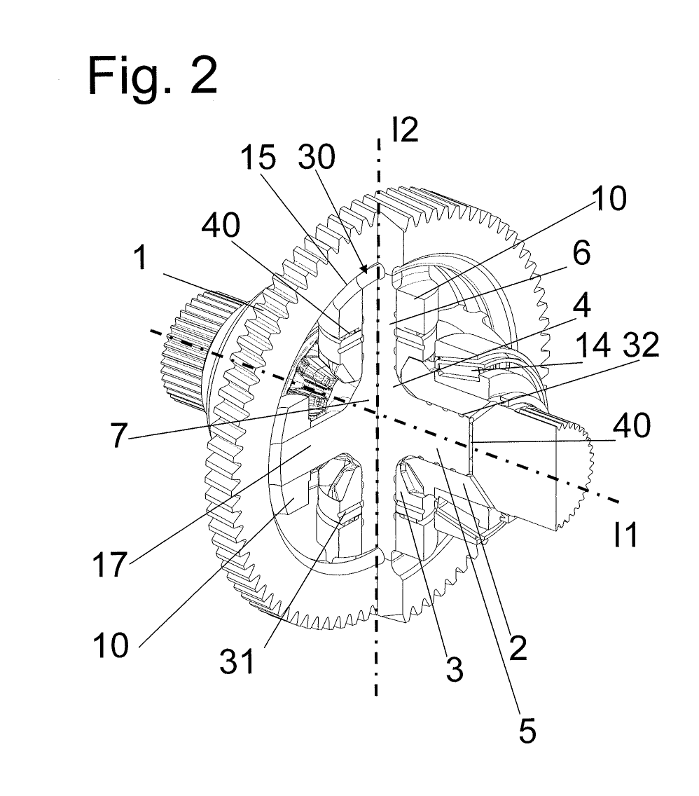

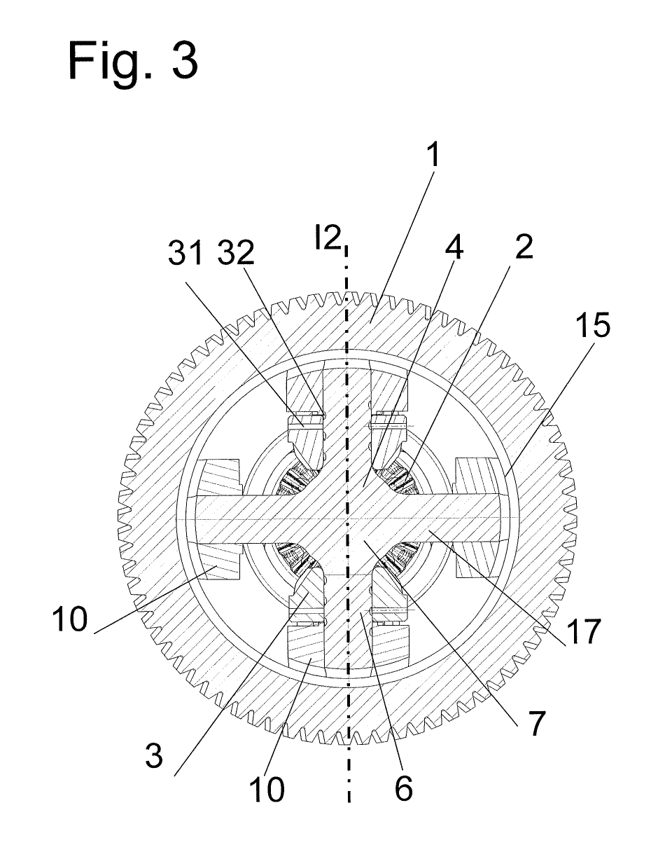

In the sectional view of FIG. 1, the connecting element 4, which is constructed as a differential cage in the prior art, is arranged inside the housing 12, essentially in the center thereof. In the present invention the connecting element has the shape of an essentially solid central region 7, from which a total of six pins extend. These pins are two axle gear pins 5, two compensating gear pins 6 and two fastening pins 17 (cf. FIGS. 2 and 3). The pins 5, 6, 17 in this case are essentially cylindrical in design. The star-shaped connecting element 4 is connected to the drive gear 1 by the two compensating gear pins 6 and the two fastening pins 17. The drive gear 1 in this case is a gearwheel or more specifically a toothed gear. The drive gear 1 has, for example, a straight, oblique, double helical or herringbone tooth system. The drive gear rotates about the first imaginary axis I1 and transmits a torque, which is dependent on the torque with which it itself is moved, to the laterally attached wheels (not shown) by way of the rotation of the axle gears 2, each of which rotates about an associated axle gear pin 5. External teeth are attached to the axle gears 2 for the purpose of connecting the differential to the vehicle axle. In this embodiment the axle gears 2 are constructed as bevel gears, wherein an essentially cylindrical unit, which has the outer teeth in this case, is attached on the base surface of each bevel gear. Furthermore, the axle gears 2 have blind bores for the purpose of receiving the axle gear pins 4. As an alternative, the axle gears 2 can also be constructed as crown gears or spur gears. The axle gears 2 are mounted directly on the axle gear pins 5 and have for an oil supply continuous drilled holes 31, through which oil, as one example of a lubricant, flows into the interspaces between the axle gear pins 5 and the axle gears 2. Tapered roller bearings 14, which provide for an axial support along the first imaginary axis I1, are provided between each of the axle gears 2 and the housing 12. In this case the tapered roller bearings 14 may be found along the first imaginary axis I1 above the region, in which the axle gears 2 are in contact with the axle gear pins 5. Thus, the forces acting on the connecting element 4 are, above all, reduced. In addition, the housing 12 is sealed off in an oil tight manner by means of seals 16 between the axle gears 2 and the housing 12. The arrangement of the axle gear pins 5 in the blind bores of the axle gears 2 prevents, among other things, the oil from running out during a disassembly. Two compensating gear pins 6 for two compensating gears 3 are provided along the second imaginary axis I2, which is perpendicular to the first imaginary axis I1. The axle gears 2 and the compensating gears 3 are constructed and arranged relative to one another in such a way that they mesh with one another. The compensating gears 3 are also disposed directly on the compensating gear pins 6 and also have continuous drilled holes 31. For a uniform distribution of the oil, the compensating gear pins 6 and the axle gear pins 5 have circumferential depressions 32. The compensating gear pins 6 are connected, for example, by welding or laser welding, to the drive gear 1 by way of the fixing regions 15. The backing pieces 10, which are positioned behind the compensating gears 3, have corresponding passages, so that the compensating gear pins 6 can be connected, for example welded, to the inner surfaces of the drive gear 1. In order to weld the compensating gear pins 6 on both sides, an essentially continuous cavity 30 is provided. This cavity is formed by grooves, for example, circumferential grooves, in the drive gear 1 and/or the compensating gear pins 6. During the welding process and as a consequence of the welding process, material of the weld root can flow into this cavity. A corresponding embodiment is provided at the fastening pins (see FIGS. 2 and 3), in so far as they are welded, as in the illustrated exemplary embodiment, to the drive gear 1.

The view from FIG. 2 shows that the four backing pieces 10 are adapted in their contour to the inner surface of the drive gear 1, in order to allow a connection, for example, by welding, that is as good as possible. Furthermore, the connecting element 4 is connected to the drive gear 1 by two fastening pins 17, wherein backing pieces 10, which are also connected to the drive gear 1, are also provided at the fastening pins 17. It can also be seen that the drilled holes 31 for the oil open into the spaces between the compensating gears 3 and the compensating gear pins 6 and/or between the axle gears 2 and the axle gear pins 5, and that from there the circumferential depressions 32 transport the oil further. In addition, thrust washers 40 are also provided behind the axle gears 2 and/or the compensating gears 3; and these thrust washers provide the favorable gliding conditions between the gears 2, 3 and the backing pieces 10 disposed behind them.

The four fastening regions 15 of the connecting element 4 by the two fastening pins 17 and the two compensating gear pins 6 can be seen the best in the sectional view in FIG. 3. It also becomes clear how the backing pieces 10 are rounded off so that they adapt to the round inner contour of the drive gear 1. The central region 7 of the connecting element 4, which is produced as a single piece, for example, by cold forming, has, for example, the shape of sphere or deviates from the spherical shape. In an additional embodiment the drilled holes in the axle gears 2 and/or in the compensating gears 3 are constructed in such a way that when tilted, each of the pins 5 and/or 6 has a plurality of, at least two, support points. This feature can be achieved, for example, in that the passage bores do not have a straight continuous course, but rather an undulation.

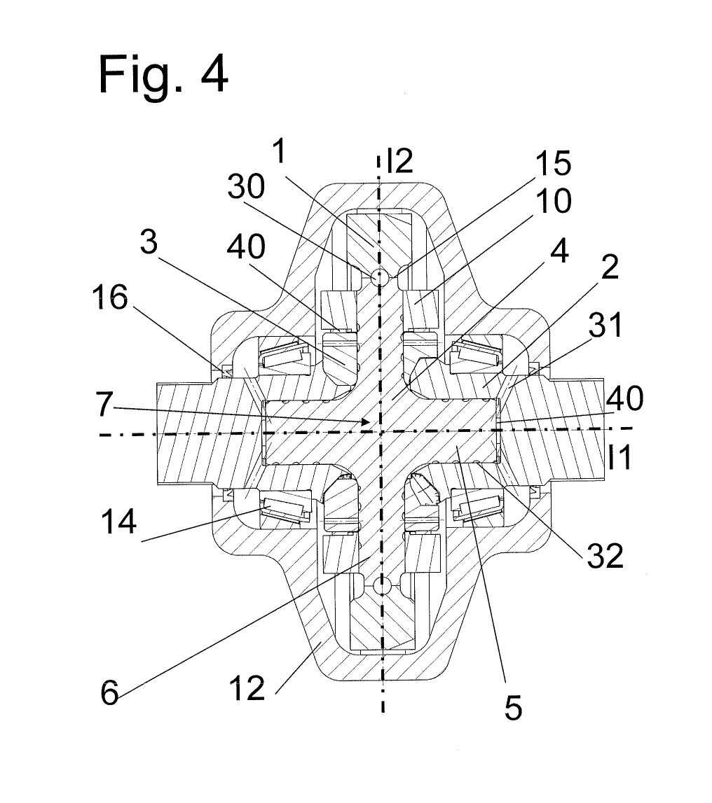

FIG. 4 shows an alternative design variant of the differential in FIG. 1. In the differential shown in FIG. 1, an O arrangement is provided for the tapered roller bearings 14, so that the pressure points lie outside the differential. This configuration is advantageous with respect to the resulting tilt moments, because even in the event that the distance between the bearing center lines is small, the tapered roller bearings 14 in the O arrangement can absorb a relatively large tilt moment. In addition, the radial forces resulting from the moment of force and the resulting deformations in the bearings are smaller than in the case of the X arrangement. Such an X arrangement of the tapered roller bearings 14 is shown in FIG. 4.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A differential, comprising:
at least one drive gear;
at least two axle gears;
at least two compensating gears; and
at least one connecting element,
wherein
the drive gear is a gearwheel that at least partially encloses an interior space,
the connecting element is constructed as a single piece and arranged at least partially inside the interior space,
the connecting element has at least six pins that extend outward from a central region of the connecting element, wherein
at least two of the at least six pins are axle gear pins configured to receive a corresponding one of the at least two axle gears rotatably mounted thereon, the at least two axle gear pins being arranged on a first axis of the connecting element,
at least two of the at least six pins are compensating gear pins configured to receive a corresponding one of the at least two compensating gears rotatably mounted thereon, the at least two compensating gear pins being arranged on a second axis of the connecting element and being connected to an inner surface of the drive gear,
the second axis is in essence perpendicular to the first axis, and
at least two of the at least six pins are fastening pins connected to the inner surface of the drive gear.

2. The differential as claimed in claim 1, wherein
the at least two axle gears have direct contact with the axle gear pins without bushings, and/or
the at least two compensating gears have direct contact with the compensating gear pins without bushings.

3. The differential as claimed in claim 1, further comprising:
at least one backing piece,
wherein
the at least one backing piece is arranged on one of the at least two compensating gear pins on a side of the compensating gears that faces away from the central region of the connecting element and is connected to the inner surface of the drive gear, and/or
the at least one backing piece is arranged on one of the at least two fastening pins and is connected to the inner surface of the drive gear.

4. The differential as claimed in claim 3, wherein
the drive gear and at least one of the at least two compensating gear pins are configured such that at least one cavity is formed between the inner surface of the drive gear and the at least one of the at least two compensating gear pins.

5. The differential as claimed in claim 3, wherein
at least one of the at least one backing piece has at least one recess through which the pin on which the backing piece is mounted extends to impinge on the inner surface of the drive gear.

6. The differential as claimed in claim 1, wherein
at least one of the at least two axle gears and/or at least one of the at least two compensating gears has at least one hole that empties into a region in which the at least one axle gear contacts its respective axle gear pin and/or in which the at least one compensating gear contacts its respective compensating gear pin.

7. The differential, as claimed in claim 1, wherein
at least one of the at least two axle gear pins and/or at least one of the at least two compensating gear pins has at least partially circumferential depressions.

8. The differential as claimed in claim 1, further comprising:
at least one housing,
wherein
ends of the at least two axle gear pins are each arranged in a blind hole of the at least two axle gears,
the at least two axle gears partially project from the housing and
the housing is essentially oil tight.

9. The differential as claimed in claim 1, wherein
the at least two axle gears are supported by tapered roller bearings arranged along the first axis at least partially in a region in which the at least two axle gears contact their respective axle gear pins.

10. The differential as claimed in claim 1, wherein
the at least two axle gears and the at least two compensating gears are bevel gears, or
the at least two axle gears are crown gears and the at least two compensating gears are spur gears, or
the at least two axle gears are spur gears and the at least two compensating gears are crown gears.
